(19) United States
(12) Patent Application Publication
(10) Pub. No.: US 2026/0161687 A1
(43) Pub. Date: Jun. 11, 2026

(54) AI SMART SEARCH ENGINE IN PRINTING COMPONENTS

(71) Applicant: KYOCERA Document Solutions, Inc., Osaka (JP)

(72) Inventor: Neil-Paul P. Bermundo, Glendora, CA (US)

(73) Assignee: KYOCERA Document Solutions, Inc., Osaka, OT (JP)

(21) Appl. No.: 18/976,032

(22) Filed: Dec. 10, 2024

(51) Int. Cl. G06F 16/334; G06F 16/332; G06F 40/284

(52) U.S. Cl. CPC G06F 16/334; G06F 16/332; G06F 40/284

(57) ABSTRACT

A system and method are disclosed for using artificial intelligence (AI) to allow non-expert users to input a prompt and receive a list of print settings related to the prompt they have provided and/or instructions describing how they may perform their desired task. For example, a user may input “booklet printing” and may be provided settings for duplex printing, feeding edge, paper size, stapling, hole punch, etc. If the user specifies “booklet media settings,” hole punch and stapling options may be omitted. A user who scans a photograph may be provided appropriate media sizes, image manipulation, and color management settings to select among.

### BACKGROUND

Among the numerous user interfaces, menus, and controls offered through printer drivers, printer panels, and printing applications, it is a challenge for a non-expert user to find the controls and input the settings that will direct a printer to create the document the user wishes to create in the quantities they need. For example, a user may use the front panel of a multifunction printer to browse through various tabs or webpage-like pages to look for a particular setting. Often the user will need to know the specific setting name, such as “Paper Size” to access that particular setting and make their desired changes.

A printer driver user interface may also have multiple tabs, each one grouping together settings or features that are deemed similar by a system designer. However, the user may wish to use settings across various groupings in combination together, and the groupings provided may not facilitate such an operation. For example, if the user wishes to print booklet, they may need to navigate to a Media tab to select paper sizes, media types, and the like. Then, they may need to find a Finishing tab for folding options, feeding edge, etc. Then, they may further need to look for settings related to color, inserts, cover, and so on.

Thus, it may be seen that user wishing to perform a particular printing operation may need to go through several user interface pages and make many selections across these pages to be able to see and modify the settings pertinent to their booklet printing task. Further, setting names, tab or page headings, groupings of settings, and the controls offered to change settings, may vary in keyword, spelling, or language from product model to product model and/or location to location. For example, what one model calls “Paper” settings another model may label “Media” settings. There is therefore a need to simplify this workflow and allow even non-expert users to instantaneously find the settings they need and to quickly access additional settings related to a particular initially selected or otherwise determined setting.

Conventional systems may use past operations as input to predict possible candidates to be used in a next operation. If no candidates are identified, such systems may use all data up to that point and use a next user operation to generate a next rule to predict next possible candidate value. Such system may be similar to predictive typing that provides suggestions as to what the user may like to use or do after doing prior operations.

In such systems, a user must still have knowledge of all printer settings in order to start any operation and be able to know what to do next. These systems only present possible values for the selected input fields in the setup screen. Upon a user's operation, they may change candidate values for the initially selected input fields. Therefore, a system is needed that is not simply predictive of existing settings but provides improved guidance for a user wishing to exercise printer settings for a complex printing task.

### BRIEF SUMMARY

In one aspect, a system includes a printing component including an AI smart search engine configured to receive an input including at least one of operating data from the printing component, a user prompt from a user, and printing component data in a database, the printing component data including at least one of printer settings, printing features, printing capabilities, printing procedures, and maintenance procedures. The system also includes a presentation layer including a response area, the presentation layer configured to at least one of receive response data from the AI smart search engine, present the response data to the user, and receive the user prompt from the user. The system also includes a prompt composer configured to receive the input to generate a search prompt that incorporates the input. The system also includes a pre-trained Generative Artificial Intelligence (GenAI) model configured to utilize the search prompt and the database to generate an output. The system also includes logic to tokenize the at least one of the operating data and the user prompt into operating data tokens and user prompt tokens suitable to prompt the pre-trained GenAI model, generate the search prompt from at least one of the operating data tokens and the user prompt tokens, analyze the search prompt to create associations and relationships with the printing component data, prompt the pre-trained GenAI model with the search prompt and receive the output from the pre-trained GenAI model, and transform the output into the response data.

In one aspect, a method includes receiving, by an AI smart search engine, an input including at least one of operating data from a printing component, a user prompt from a user, and printing component data from a database, where the printing component data includes at least one of printer settings, printing features, printing capabilities, printing procedures, and maintenance procedures. The method also includes receiving, by a prompt composer, the input, generating, by the prompt composer, a search prompt that incorporates the input. The method also includes analyzing, by the AI smart search engine, the search prompt to create associations and relationships with the printing component data. The method also includes utilizing, by a pre-trained Generative Artificial Intelligence (GenAI) model, the search prompt and the database to generate an output. The method also includes transforming, by the AI smart search engine, the output into response data; and presenting, by a presentation layer, the response data to the user, where the presentation layer includes a response area and is configured to at least one of receive the response data from the AI smart search engine, present the response data to the user, and receive the user prompt from the user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a printing system 100 in accordance with one embodiment.

FIG. 2 illustrates an AI smart search system 200 in accordance with one embodiment.

FIG. 3 illustrates an AI smart search engine 300 in accordance with one embodiment.

FIG. 4 illustrates an exemplary tokenizer 400 in accordance with one embodiment.

FIG. 5 illustrates a routine 500 in accordance with one embodiment.

FIG. 6 illustrates a routine 600 in accordance with one embodiment.

FIG. 7 illustrates a routine 700 in accordance with one embodiment.

FIG. 8 illustrates a subroutine 800 in accordance with one embodiment.

FIG. 9 illustrates a subroutine 900 in accordance with one embodiment.

FIG. 10 illustrates a subroutine 1000 in accordance with one embodiment.

FIG. 11A illustrates inference and/or training logic 1100a in accordance with one embodiment.

FIG. 11B illustrates inference and/or training logic 1100b in accordance with one embodiment.

FIG. 12 illustrates a deep neural network 1200 in accordance with one embodiment.

FIG. 13 illustrates a basic deep neural network 1300 in accordance with one embodiment.

FIG. 14 illustrates an artificial neuron 1400 in accordance with one embodiment.

FIG. 15 illustrates an embodiment of a computational apparatus 1500 to implement components and process steps of the system described herein.

FIG. 16 illustrates a cloud computing environment 1600 in accordance with one embodiment.

FIG. 17 illustrates a set of functional abstraction layers 1700 in accordance with one embodiment.

### DETAILED DESCRIPTION

The solution disclosed herein uses artificial intelligence (AI) to allow even causal or non-expert users to input a prompt and receive a list of print settings related to the prompt they have provided and/or instructions describing how they may perform their desired task. For example, a user may input “booklet printing” and may be provided settings for duplex printing, feeding edge, paper size, stapling, hole punch, etc. If the user specifies “booklet media settings,” hole punch and stapling options may be omitted. A user who scans a photograph may be provided appropriate media sizes, image manipulation, and color management settings to select among.

The disclosed solution implements an AI smart search engine which uses predictive and generative artificial intelligence in order to predict which settings may help the user achieve their desired task and generate instructions and/or user interface controls for presentation to the user to facilitate their task.

In this manner, the disclosed solution may improve user experience in using any printing component, whether it is printer driver, a printer admin webpage, a printer panel, or any printing application. This adds value to the printer, especially in the areas of ease-of-use, maintenance, color quality monitoring, report generations, scheduled tasks, optimal use of resources, and improved performance through reducing errors due to missed settings or steps. The disclosed solution thus saves time for users, technicians, and print production shops performing printing tasks.

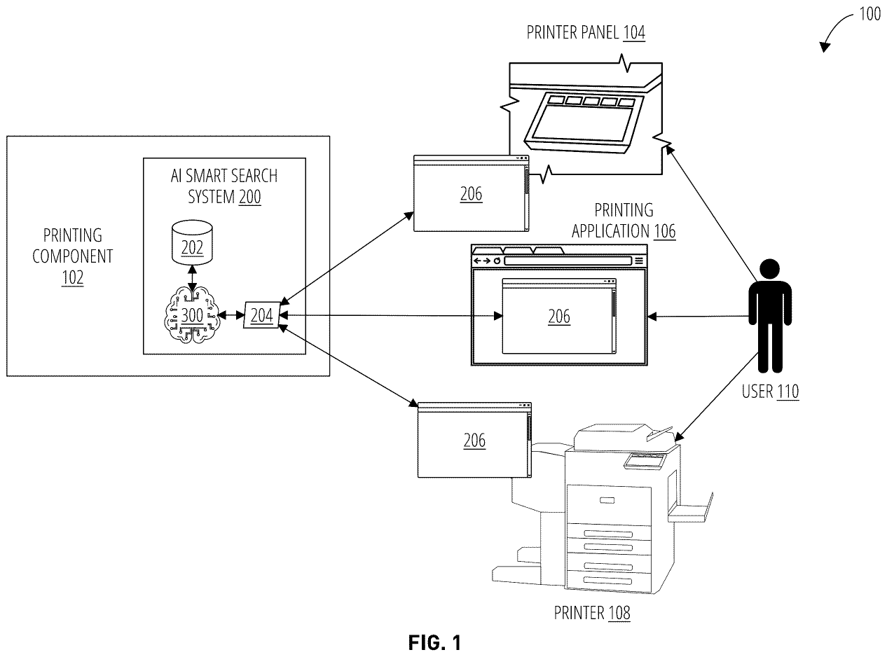

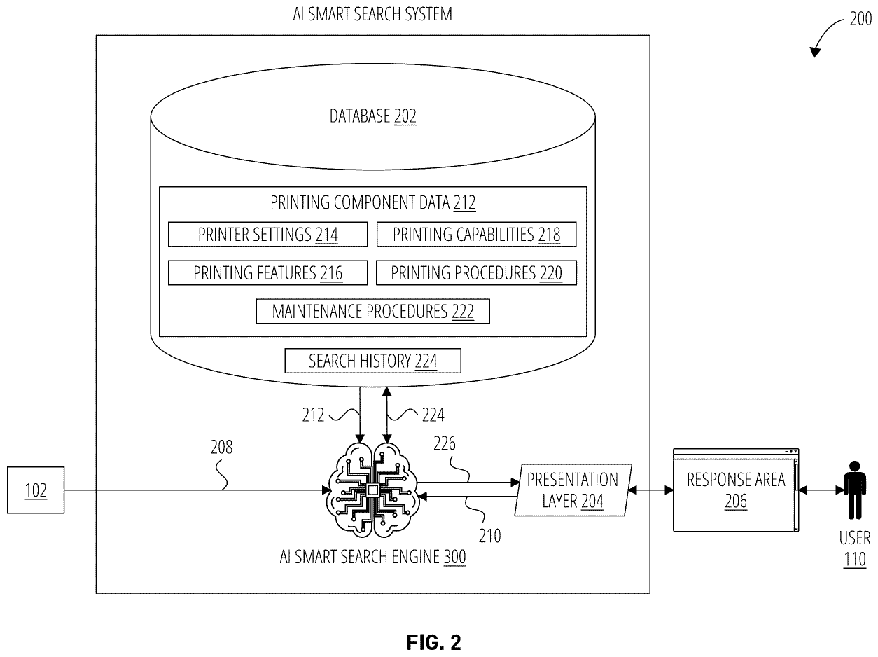

FIG. 1 illustrates a printing system 100 in accordance with one embodiment. The printing system 100 may comprise a printing component 102 configured to communicate with a response area 206 provided on a printer panel 104, printing application 106, a printer 108, etc. The printing component 102 may printer panel 104 firmware, a printing application 106 such as Digital Front End, printer 108 firmware, a printer admin webpage, etc. The printing component 102 may include the AI smart search system 200 comprising the AI smart search engine 300, database 202, and presentation layer 204 introduced with respect to FIG. 2.

The AI smart search engine 300 may be the core component of the printing system 100 which includes the AI smart search system 200. The AI smart search engine 300 may receive a search prompt or request from a user, who may be interacting with the response area 206 provided via the printer panel 104, printing application 106, printer 108, or some other device in communication with the printing system 100. The AI smart search engine 300 may analyze and interpret the prompt to create associations and relationships with the data in the database 202 pertaining to settings, printer capabilities and features, and printing procedures. The AI smart search engine 300 may gather all related settings, data, procedures, user interfaces, and reports that are related to the user prompt or request, and may generate reports, procedures, user interfaces, etc., to present the results to the user in the response area 206.

As described above, the database 202 may be the repository of all data for the AI smart search system 200. Such data may include settings like the configuration file for the printing component, such as a PostScript Printer Description .ppd file for printer drivers, .json files for printing applications, .xml files or .xsd files for Job Definition Format (JDF) or Exchange JDF (XJDF) systems, .cfg files for other applications, or any other configuration files used for the printing component 102. Configuration data may also be saved in database files or systems that may reside locally or remotely in relation to the printing system 100 where the AI smart search system 200 operates.

The database 202 may also store printing features or capabilities. This may include saving Windows DevMode to a file or other repository. Printing features or capabilities may be saved in text or binary files, in some identified file formats, that may contain data describing printing features or capabilities. The database 202 may store printing procedures that are descriptive of or outline printing tasks that may be performed in the printing component, such as a step-by-step guide for doing booklet printing, step-by-step guide for printing with a media catalog (which may include use of color management data such as International Color Consortium (ICC) profiles), a step-by-step guide in printing a study guide, a step-by-step guide in printing diagrams, tables, tabulations, and statistics. This data may be saved in a configuration file, such as a JavaScript Object Notation (JSON) or Extensible Markup Language (XML) file that may be processed, manipulated, shared, and displayed in the printing system 100.

The database 202 may store maintenance procedures. These are descriptive of or outline printing tasks that may be performed in the printing component, such as a step-by-step guide in performing print head alignment, color registration, memory initialization, etc., a step-by-step guide in loading media and making any associated setting changes in certain trays, and a step-by-step guide in cleaning ink waste bins, etc. This data may be saved in a configuration file, such as a JSON or XML file that may be processed, manipulated, shared, and displayed in the printing system 100. Step-by-step guides stored in the database 202 may include AI-generated step-by-step guides of various combinations of the above data, among others, that may result in new steps or combinations of pre-identified steps, such as those the AI smart search system 200 may generate or locate.

The presentation layer 204 may handle, manage, update, and monitor the response area 206 in the printer printing component 102 user interface, such as may be included in the printer panel 104, printing application 106, printer 108, etc. The presentation layer 204 may receive response data from the AI smart search system 200 and may display, send, print, or present re-formatted or arranged response data to the user in the response area 206.

The presentation layer 204 may process the response data and may transmit it to selected or pre-determined destination(s), which may be a television, a display/monitor, a printer panel 104, a printing application dialog, a wizard-like tabbed user interface, a webpage, etc. A tabbed or wizard-like interface may guide the user in achieving or performing a printing task. A report may be in a textual outline format that serves as a guideline to the user.

The presentation layer 204 may broadcast the response data to many connected devices, such as mobile devices, smartphones, the Internet, televisions, laptops, or other devices able to receive video-feed, streaming data, email, printout, etc. The presentation layer 204 may manages how the response data are presented to the user in the reserved area in the printing component user interface described herein as the response area 206. If a user unselects an interactive setting shown in the response area 206, the presentation layer 204 may modify, remove, or add to a previously presented set of settings, such as specific options/values for selected settings, any textual suggestions or recommendations, diagrams, or any dynamic data generated or displayed in the response area 206 in the printing component user interface.

As a user un-checks, un-selects or excludes a previously suggested setting/option in the response area 206, the presentation layer 204 may relay to AI smart search engine 300 to exclude such an option or set of options from further or future considerations in AI smart search engine 300 processing. Any option, value, setting, text, diagram or dynamic data that gets added and displayed in the response area 206 as a result of prior action may also be signaled to the AI smart search engine 300 so that such data may be included in subsequent or future considerations in the AI smart search engine 300 processing.

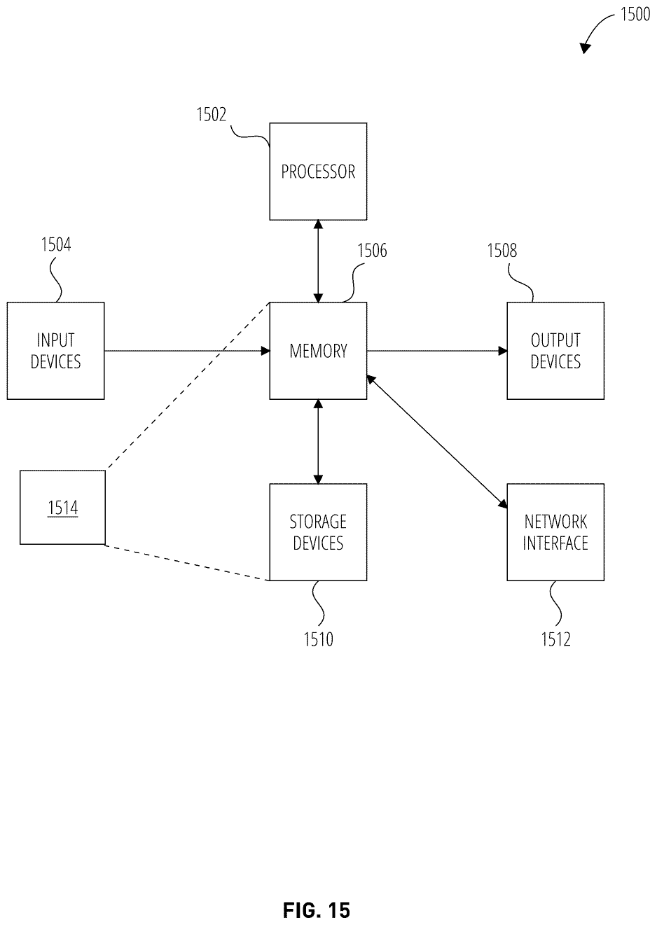

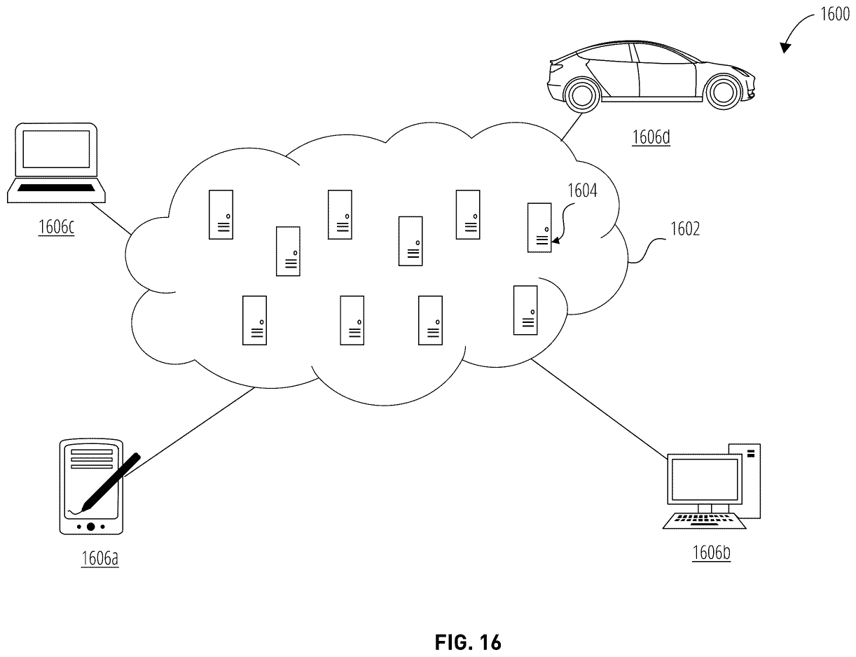

The printing system 100 that integrates the AI smart search system 200 may be supported by computing devices such as the computational apparatus 1500 described with respect to FIG. 15 and cloud computing resources such as the cloud computing environment 1600 described with respect to FIG. 16 in order to perform the communicative and computational operations involved in implementing the disclosed solution.

FIG. 2 illustrates an AI smart search system 200 in accordance with one embodiment. The AI smart search system 200 may include an AI smart search engine 300, a database 202, a presentation layer 204, and may be in communication with a response area 206.

The AI smart search system 200 may be implemented in a printing component 102 as shown in FIG. 1. The AI smart search engine 300 may be the core component of the AI smart search system 200 that receives user prompts or requests for settings through an interface in the printer component (printer driver, printer panel, webpage, menu or dialog, for example). The AI smart search engine 300 may use AI to respond to the user prompt or request to present to the user a better, clearer, and direct-to-the-point list of settings or guide to help the user achieve or perform a printing task.

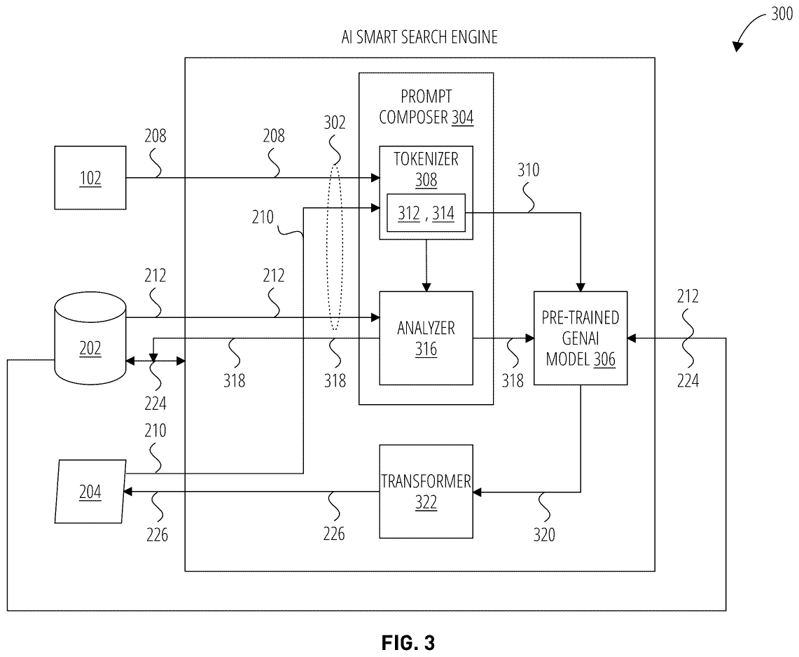

The AI smart search engine 300 may be trained to learn how to group together settings, relate settings to one another, and present new combinations of settings, procedures, steps, reports, etc., that may assist a user to achieve a print action or that may respond to the user's prompt or request. The AI smart search engine 300 may, for example, generate a guide on how the user may achieve or perform a printing task that may initially sound or look complicated to the user. The AI smart search engine 300 is described in additional detail with respect to FIG. 3.

The database 202 may store all data including printing component data 212, which may include printer settings 214, printing features 216 and printing capabilities 218, printing procedures 220, maintenance procedures 222, etc. This may include descriptive details about each of those settings and user interfaces in the printer component, which may be a printer driver, application, printer panel, webpage, maintenance menus or dialogs, or printable reports. This may further include descriptions, bitmaps, or screenshots of the related user interfaces so that the system may show and illustrate to the user where in the software, firmware, or application the settings being reported may be found or where some procedure may be performed.

The database 202 may also store and maintain generated new data as part of a search history 224 that describes, consolidates, and creates associations and relationships between the settings, capabilities, features, and data that may be determined through use of machine learning and AI technologies. Generative AI may support creation of descriptive and meaningful associations identifying settings that may be related to a task or goal. For example, if user specifies “booklet printing media,” the system may generate and present the settings for “paper size,” “orientation,” “media type,” “cover,” etc., but may exclude finishing options such as “stapling” and “hole punch.” As another example, if a user specifies “create ICC profile given a picture,” the system may generate a guideline for the user to follow in order to create new media based on the color information or measurements in a picture or diagram provided by the user. The reports or guidelines that the AI smart search engine 300 generates may be saved in the database 202 for future reuse, as basis for future analysis, and/or for combination to generate future data for a new kind of report.

The presentation layer 204 may be configured to receive response data 226 from the AI smart search engine 300, present the response data 226 to a user 110, and receive a user prompt 210 from the user 110. The response data 226 that the AI smart search engine 300 may generate for presentation to the user 110 may be a printed report, a displayed report in a user interface, webpage, dialog, or a wizard-like dialog that may be used as a guideline the user 110 may follow to achieve or perform a printing task. The presentation layer 204 may generate a new user interface that shows list of prompts or guidelines that may match what the user 110 is looking for. For example, instead of the user 110 seeing a tabbed interface of settings, the user 110 may initially see an interface with bulleted options, such as:
Print a simplex document on white A4 paper.
Print a booklet on thick paper.
Create new paper media based on a color measurement diagram loaded on the scanner tray.
Perform color calibration at end of the day.
Warm-up when staff arrives in the morning.
Print latest statistics/reports for R&D team members before their next meeting.

The presentation layer 204 may include a response area 206. The response area 206 may be an area reserved or implemented in the printing component user interface that interacts with the presentation layer 204. Whichever printing component integrates the AI smart search system 200 (e.g., printer driver dialog, printing application user interface, printer panel, printer administration webpage, etc.), an area in the user interface for that component may be reserved or implemented for showing feedback, activity, status, and responses from the AI smart search system 200. The response area 206 for this system may be an area that dynamically shows system settings, textual, graphical, and diagrammatic responses, printing component statistics, printing component status, and so on. The response area 206 may display system settings, options, features, capabilities, or sub-menus that the user may interact with for influencing how the AI smart search engine 300 makes use of the data. The user may add or exclude settings in the response area 206. The user 110 may select any desired or related settings. The response area 206 may thus support user interaction with the AI smart search system 200.

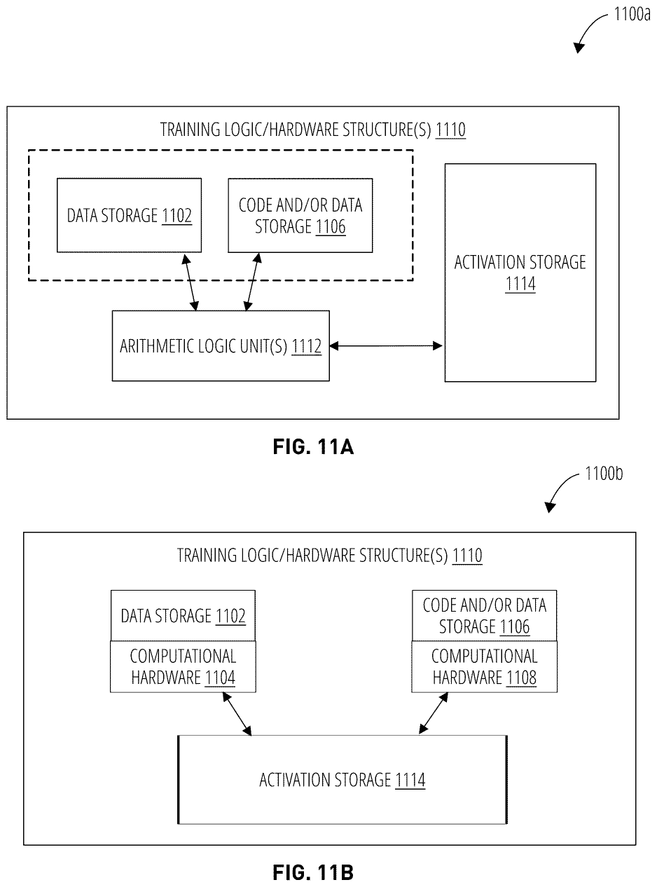

FIG. 3 illustrates an AI smart search engine 300 in accordance with one embodiment. The AI smart search engine 300 may reside and operate via logic configured on one or more processors, such as graphics processing units (GPUs) or central processing units (CPUs), as part of a computational apparatus as described in FIG. 15 or a computing device, such as in described in FIG. 16. The AI smart search engine 300 may comprise a prompt composer 304 and a pre-trained GenAI model 306. The pre-trained GenAI model 306 may be trained and may operate as described with respect to FIG. 11A-FIG. 14. The pre-trained GenAI model may fully or partially reside locally on the printing component or be fully or partially accessible via a cloud computing environment.

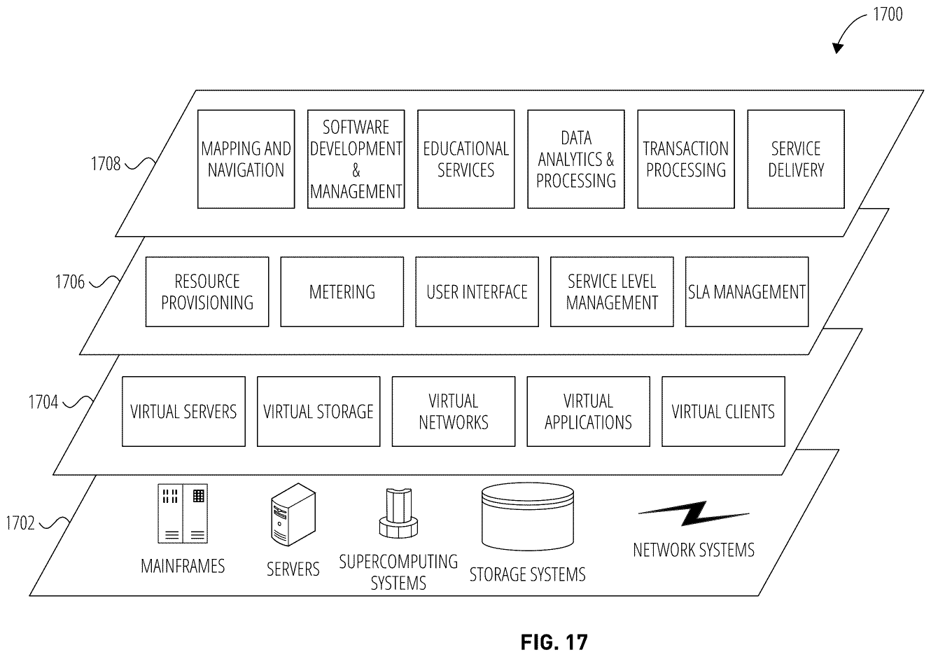

The AI smart search engine 300 may further comprise logic in the form of a tokenizer 308, and analyzer 316, and a transformer 322, which may operate upon the data input to the AI smart search engine 300 as described below. This logic may reside within the prompt composer 304 as shown or may be configured within separate functional modules of the AI smart search engine 300, either locally or accessible via a cloud computing environment, such as is described with respect to FIG. 16 and FIG. 17.

The prompt composer 304 may be configured to receive an input 302 to generate a search prompt 310 that incorporates the input 302. The input 302 may include the operating data 208 from the printing component 102, the user prompt 210 from the presentation layer 204, and the printing component data 212 from the database 202. The pre-trained GenAI model 306 may be configured to utilize the search prompt 310 and the database 202 to generate an output 320.

The tokenizer 308 may include logic to tokenize the at least one of the operating data 208 and the user prompt 210 into operating data tokens 312 and user prompt tokens 314 suitable to prompt the pre-trained GenAI model. The prompt composer 304 may include logic to generate the search prompt 310 from at least one of the operating data tokens 312 and the user prompt tokens 314. The analyzer 316 may include logic to analyze the search prompt 310 to create associations and relationships 318 with the printing component data 212. In one embodiment, the associations and relationships 318 may be available to the pre-trained GenAI model 306 for use in generating the output 320. In one embodiment, the associations and relationships 318 may be sent to the database 202 for storage as part of the search history 224.

The database 202 data, such as printing component data 212 and search history 224, may further be available to the pre-trained GenAI model 306 for use in generating the output 320. In this manner, the logic of the AI smart search engine 300 may be configured to prompt the pre-trained GenAI model 306 with the search prompt 310 and receive the output 320 from the pre-trained GenAI model 306.

The transformer 322 of the AI smart search engine 300 may include logic to transform the output 320 from the pre-trained GenAI model 306 into the response data 226 (report, dialog, guideline, etc.). In one embodiment the output may include a recommendation of which form the response data 226 may take to best convey the information to the user 110. The response data 226 from the transformer 322 may then be sent to the presentation layer 204 for display to the user 110.

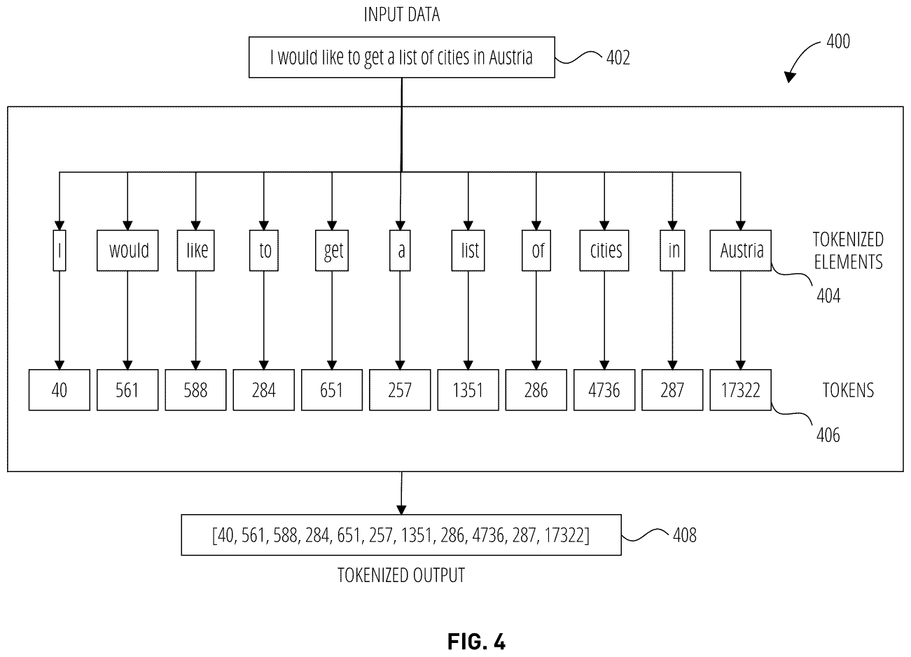

FIG. 4 illustrates an exemplary tokenizer 400 in accordance with one embodiment. Input data 402 may be provided to the exemplary tokenizer 400 in the form of a text string typed by a user. In one embodiment, the text string may be generated by performing voice-to-text conversion on an audio stream. The exemplary tokenizer 400 may detect tokenizable elements 404 within the input data 402. Each tokenizable element 404 may be converted into a token 406. The set of tokens 406 created from the tokenizable elements 404 of the input data 402 may be sent from the exemplary tokenizer 400 as tokenized output 408. The set of tokens 406 may be such as are used to create the search prompt 310 of FIG. 3.

For structured historical data such as plaintext, database, or web-based textual content, tokens may consist of the numerical indexes in an embedded or vectorized (e.g., word2vec or similar) representation of the text content such as are shown here. In some embodiments, a machine learning technique called an autoencoder may be utilized to transform plaintext inputs into high dimensional vectors that are suitable for indexing and tokenization ingestion by the prompt composer 304 introduced with respect to FIG. 3.

In some embodiments, data to be tokenized may include audio, visual, or other multimodal data. For images, video, and similar visual data, tokenization may be performed using a convolution-based tokenizer such as a vision transformer. In some alternate embodiments, multimodal data may be quantized and converted into tokens 406 using a codebook. In yet other alternate embodiments, multimodal data may be directly encoded and for presentation to a language model as a vector space encoding. An exemplary system that utilizes this tokenizer strategy is Gato, a generalist agent capable of ingesting a mixture of discrete and continuous inputs, images, and text as tokens.

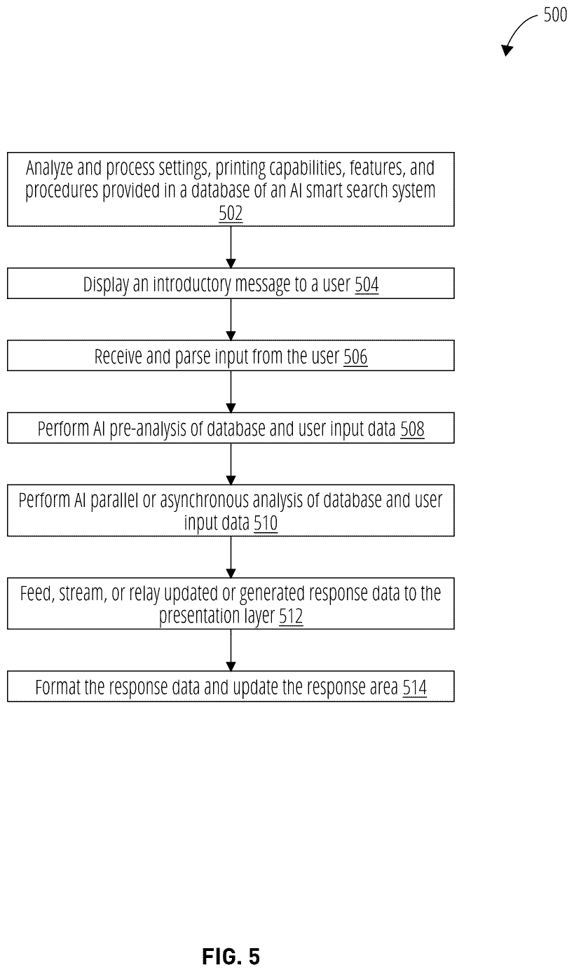

FIG. 5 illustrates a routine 500 in accordance with one embodiment. FIG. 5 illustrates an example routine 500 that may be performed by the AI smart search system 200 introduced in FIG. 2. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

According to some examples, the method includes analyzing and process settings, printing capabilities, features, and procedures provided in a database of an AI smart search system at block 502. For example, the AI smart search engine 300 illustrated in FIG. 2 may analyze and process settings, printing capabilities, features, and procedures provided in a database of an AI smart search system. The database may be preconfigured with data pertinent to the printing component and printing system the ai AI smart search system is configured on. This data may come from the factory or from a development site. The database may be updated as new data is provided by developers and users, and as new data is generated by the AI smart search system. New data may be saved in the database and the AI smart search engine may learn from new data entry and from data created as users interact with the printing system.

According to some examples, the method includes displaying an introductory message to a user at block 504. For example, the response area 206 illustrated in FIG. 2 may display an introductory message to a user. The introductory message may inform the user whether or not the AI smart search engine is active or disabled. If active, the message may inform user that the AI smart search system is analyzing user actions in real-time and that it may present suggestions, relevant information or settings, and wait for further user actions, prompts, filters, or suggestions. The introductory message may offer a selection of preconfigured prompts or queries for selection by the user.

According to some examples, the method includes receiving and parse input from the user at block 506. For example, the AI smart search engine 300 illustrated in FIG. 2 may receive and parse input from the user. The user input may prompt the AI smart search engine with requests for settings, instructions, task descriptions, etc. Initial user input data may be an initial printer component operation that the user performs, such as selecting the Media tab in a printer driver, going to the Copy page in a printer panel, or going to landing page in a printing application such as Digital Front End (DFE). As the user selects settings, the AI smart search engine may remember the selected settings or user interface location used by the user thus far. The user input may include a selection from a menu of prompts or text entry of a user query. Some prompts offered may be historical or previous prompts that the user or other system users have entered on the system. Some prompts may be pre-defined prompts such as the following examples:
Settings examples
   Booklet printing settings
   Booklet printing media settings
Printing tasks
   Print a simplex document on white A4 Letter
   Print a booklet on thick paper
   How to print a booklet?
   How to print a diagram based on an Excel file worksheet with data?
   Print a calendar
Maintenance tasks
   How to calibrate printer for color conversion?
   Check color quality for a media
   Warm-up when staff arrives in the morning
Creative tasks
   Provide steps to print a set of photographs?
   Select which media/paper to use?
   Select which filters to use for optimal color quality?
   How to save ink in printing a book with 1000 pages?
Color management
   Create new paper media based on a color measurement diagram loaded on the scanner tray
   Show which paper catalog media have similar color quality for printing my document
Scheduled tasks
   Print latest statistics/reports for R&D team members before their next meeting
   Perform color calibration at the next best time when there are no print jobs in the queue and the printer may potentially not be busy

According to some examples, the method includes performing AI pre-analysis of database and user input data at block 508. For example, the AI smart search engine 300 illustrated in FIG. 2 may perform AI pre-analysis of database and user input data. The AI smart search engine may begin to detect and analyze input data. If the input data or print job includes an image, the AI smart search engine may prepare settings, options, and features related to printing a photograph by-itself, as a photobook (if there are more than one photographs or images), or as an illustration page (if there's a letterhead, cover page, collage style). Photo glossy paper may be gathered as initial set of options. Color optimizations may be included. The printer may be set up for color printing. Cleaning of dust, focus adjustment, alignment, and similar operations may be included. If the input data or print job includes a document such as a Portable Document Format (PDF), a Microsoft Word file, a webpage, or similar file, the engine may prepare settings for printing a document, such as A4-media or other regular media types (non-production printing media) and monochrome and color printing options.

According to some examples, the method includes performing AI parallel or asynchronous analysis of database and user input data at block 510. For example, the AI smart search engine 300 illustrated in FIG. 2 may perform AI parallel or asynchronous analysis of database and user input data. The AI smart search engine may use printer settings data and printing procedures data to formulate suggestions, responses, or output for the user prompt or user request thus far. With all data and any user action on the printer component considered, the AI smart search engine may use machine learning training data, to prepare, formulate, and generate a response. The AI smart search engine may use historical data to provide lists of “most recently used settings, features, procedures, responses,” or lists based on other criteria such as “least recently used,” “most shared,” “most discussed,” “most recommended,” “most efficient method,” “most ink-efficient,” etc. As the user selects and makes changes in the printing component user interface, the AI smart search engine may perform additional analysis and processing in the background and determine or formulate responses.

According to some examples, the method includes feeding, stream, or relay updated or generated response data to the presentation layer at block 512. For example, the AI smart search engine 300 illustrated in FIG. 2 may feed, stream, or relay updated or generated response data to the presentation layer.

According to some examples, the method includes formatting the response data and update the response area at block 514. For example, the presentation layer 204 illustrated in FIG. 2 may format the response data and update the response area. The presentation layer may receive response data from the AI smart search engine and may determine how best to format and present the response data. it may then update the response area with the formatted and prepared response data. In one embodiment, the presentation layer may transmit the combination of formatted or prepared response data to the user. The data may be displayed to a display device, printed to printer, sent by email, etc. The transmission method determined upon may be enforced by user choice, set in system configuration, or selected in ways deemed applicable by the AI smart search system, such as a Microsoft PowerPoint or slide presentation, a television broadcast, web-or media-streaming broadcast, etc.

As the user selects additional settings or makes changes to settings in the printing component user interface, the AI smart search system 200 may perform additional pre-analysis and parallel/asynchronous processing to formulate and determine alternative or additional sets of suggestions. For example, if the user selects duplex printing, the AI smart search system 200 may note what other settings may be applicable or relevant to duplex printing. It may omit photographic paper, thin paper, transparencies, and the like from options presented, and instead include media types that are suitable for printing in dual sides. If the user selects booklet printing, the AI smart search system 200 may perform its analysis, and may determine to adjust a previous set of response data, excluding thick paper or media types that may be hard to fold in the printer engine. It may exclude stapling if booklet is performed using glue or just folding.

In one embodiment, the AI smart search system 200 may follow the routine 500 to generate various procedures to guide the user in performing printing tasks. For example, the AI smart search system 200 may provide a step-by-step guide, report, or webpage with details on what specific high-quality paper catalog media to load in the paper trays, what feeding edge, orientation, and other settings to set up for printing a set of pages. The step-by-step guide may tell the user what photographic, camera, or lens filters to apply to images to achieve effects on the printout. It may auto-adjust contrast so that page content is visible after the filter is applied. Exemplary actions the AI smart search system 200 may perform following routine 500 based on various user prompts may be as follows.
Prompt: Print PDF document as a booklet
   The AI smart search system 200 may present settings related to booklet printing.
      The AI smart search system 200 may:
         Show media types that are applicable to printing, and thus exclude photographic paper, thin papers, transparencies, envelopes, etc.
         Exclude paper types that are thick or large paper sizes that the printer engine may not be able to fold.
      The AI smart search system 200 may also show settings or options for front cover sheet, title page, insert or section headers, back cover sheet, etc.
      The AI smart search system 200 may show settings or options for binding methods (glue, stapling, folding, etc.).
      The AI smart search system 200 may show other relevant settings such as binding edge, orientation, number of sheets that may be grouped before binding, etc.
   As the user interacts with the user interface and makes changes in settings or options, the system may dynamically adapt and present options, suggestions, or responses that the user may follow or perform.
   The user may in this manner be guided in performing a booklet printing task.
Prompt: Which media are suitable for printing 1000 copies of a photograph?
   The AI smart search system 200 may check the number of available paper media that may be used for photo printing.
      The AI smart search system 200 may show statistics of how many of such media are left, so the user may consider which media to pick to go forward with printing.
      The AI smart search system 200 may warn the user that if certain paper is used, more paper supply may need to be preordered so that printing may continue uninterrupted or so that printing may be completed on the desired date.
   The AI smart search system 200 may analyze scanned pictures or pictures in document/PDF/Printer Control Language (PCL)/XML Paper Specification (XPS) format to see if any alignment, noise cleaning, or filtering may be done, and may present those options if deemed needed.
      In one embodiment these options may be a configurable setting that shows those options if an input document or selected printing scenario includes photographs or illustrations.
   The AI smart search system 200 may select output trays to direct output to such that the total number of pages may be accommodated without having to empty out the trays during the task or monitor the output trays for overflow.
Prompt: Maintenance task-Perform ink calibration for a media
   The AI smart search system 200 may show media that may be due to color calibration.
      Ordering may be oldest calibrated media to most recently calibrated media or vice versa.
   The AI smart search system 200 may show instructions where to load certain media.
      The AI smart search system 200 may show instructions on how to load media.
      The AI smart search system 200 may show instructions on what to do once media is scanned.
      The AI smart search system 200 may show instructions on how to save measurements.
      The AI smart search system 200 may show information on how to find and use the re-calibrated media.
Prompt: Maintenance task-Check color quality of media
   The AI smart search system 200 may show instructions on how to prepare media for color quality check.
   The AI smart search system 200 may show instructions on what to do once media is scanned.
   The AI smart search system 200 may show instructions on how to save measurements.
   The AI smart search system 200 may show information on how to find and use the refreshed media.
Prompt: Maintenance task or admin task-Warm-up when staff arrives in the morning
   The AI smart search system 200 may gather credentials and authorization for which staff will be allowed to use the printer.
   The AI smart search system 200 may gather which printers will be applicable or accessible to the staff.
   The AI smart search system 200 may create scheduled task to start warm-up process for engine for validated staff members.
   The AI smart search system 200 may create schedule task to send message to other printers for the validated staff members.
Prompt: Creative tasks-Print a set of photographs
   The AI smart search system 200 may perform media selection.
      Similar to above, the AI smart search system 200 may check and analyze available media supply to find out:
         Which media is suitable for printing photographs and show those media that are available.
         Which media has enough supply and exclude those that do not.
         Which media may have degraded color quality since they were calibrated based on time elapsed since the last calibration.
   The AI smart search system 200 may determine needed processing features or effects.
      The AI smart search system 200 may detect if photographs need alignment, noise cleaning, filtering, and the like.
      The AI smart search system 200 may show available filters to use for effects, contrast, brightness, or other color quality parameters.
      The AI smart search system 200 may show options for doing collage, layouts, frames, and the like.
   The AI smart search system 200 may provide a cost estimation when printing a set of photographs given the chosen features, capabilities, and paper media.
Prompt: Perform color management tasks
   The AI smart search system 200 may show various color management tasks that may be performed, such as Initial Color Calibration, ICC Profile Creation, and other quality control job processes.
      The AI smart search system 200 may show steps on how setup and perform each color management process.
      The AI smart search system 200 may show information on where new measurement data and/or media are saved.
      The AI smart search system 200 may show information on how to find the new/updated media during printing tasks.
   The AI smart search system 200 may show which other paper catalog media may have similar color measurement data or quality as the new or updated media.
Prompt: Scheduled tasks-Color registration and head cleaning
   The AI smart search system 200 may use historical data to determine when is the best time to perform the set of scheduled tasks.
   The AI smart search system 200 may consider pre-defined schedules like:
      Times when the least number of printer users are expected in the office or shop.
      Times when there is no scheduled power outage, janitor use of power, or other building maintenance jobs.
   The AI smart search system 200 may present scheduling options to a manager, administrator, or technician for scheduling confirmation.

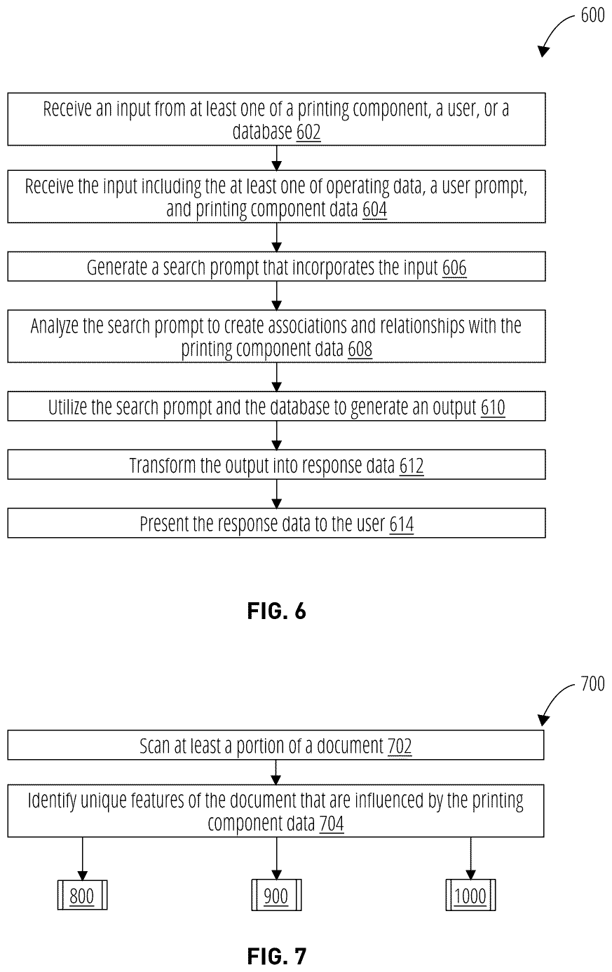

FIG. 6 illustrates an example routine 600 that may be performed by the AI smart search system 200. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

According to some examples, the method includes receiving an input from at least one of a printing component, a user, or a database at block 602. For example, the AI smart search engine 300 illustrated in FIG. 3 may receive an input from at least one of a printing component, a user, or a database. The input may include at least one of operating data from a printing component, a user prompt from a user, and printing component data from a database. The printing component data may include at least one of printer settings for printing different document types, printing features, printing capabilities, printing procedures, and maintenance procedures. The printing procedures may include at least one of descriptive printing procedures that may be performed in the printing component, outline printing procedures that may be performed in the printing component, and step-by-step guides for performing the printing procedures. The maintenance procedures may include performing, using a step-by-step guide, at least one of: print head alignment, color registration, and memory initialization, performing, using a step-by-step guide, at least one of: loading media and making associated setting changes in certain media trays, and cleaning, using a step-by-step guide, ink waste bins. The printing component may be at least one of a printer driver, a printer panel firmware, a printer firmware, a printer application, and software including a Digital Front End (DFE) application. Prompts from the user may be for settings examples, printing tasks, maintenance tasks, creative tasks, color management, and scheduled tasks.

According to some examples, the method includes receiving the input including the at least one of operating data, a user prompt, and printing component data at block 604. For example, the prompt composer 304 illustrated in FIG. 3 may receive the input including the at least one of operating data, a user prompt, and printing component data.

According to some examples, the method includes generating a search prompt that incorporates the input at block 606. For example, the prompt composer 304 illustrated in FIG. 3 may generate a search prompt that incorporates the input. The search prompt may be generated using operating data tokens and user prompt tokens created by the prompt composer 304. The tokenizer 308 logic may be used to create these tokens.

According to some examples, the method includes analyzing the search prompt to create associations and relationships with the printing component data at block 608. For example, the prompt composer 304 illustrated in FIG. 3 may analyze the search prompt to create associations and relationships with the printing component data. The analyzer 316 logic may be used to analyze data for these associations and relationships.

According to some examples, the method includes utilizing the search prompt and the database to generate an output at block 610. For example, the pre-trained GenAI model 306 illustrated in FIG. 3 may utilize the search prompt and the database to generate an output.

According to some examples, the method includes transforming the output into response data at block 612. For example, the AI smart search engine 300 illustrated in FIG. 3 may transform the output into response data. This transformation may be performed by the transformer 322 logic.

According to some examples, the method includes presenting the response data to the user at block 614. For example, the presentation layer 204 illustrated in FIG. 2 may present the response data to the user. The presentation layer may include a response area. The presentation layer may be configured to receive the response data from the AI smart search engine, present the response data to the user, and receive the user prompt from the user. The response area may be configured to display at least one of dynamic system settings, textual responses, graphical responses, diagrammatic responses, printing component statistics, and printing component status.

In one embodiment, the routine 600 may include performing a procedure in the response data or following a step-by-step guide in the response data. The response data may include at least one of procedures that guide the user in performing printing tasks and step-by-step guides with details on at least one of selecting specific media to load into the printing component, loading a specific feeding edge of media into the printing component, and orientating media to load into the printing component.

FIG. 7 illustrates an example routine 700 that may be performed by the AI smart search system 200. Although the example routine 700 depicts a particular sequence of operations, the sequence may be altered without departing from the scope of the present disclosure. For example, some of the operations depicted may be performed in parallel or in a different sequence that does not materially affect the function of the routine 700. In other examples, different components of an example device or system that implements the routine 700 may perform functions at substantially the same time or in a specific sequence.

According to some examples, the method includes scanning content in at least a portion of a document at block 702. The scan may be performed on a document presented on physical media, such as a paper document, or on a document presented as a digital file, such as a PDF. According to some examples, the method includes identifying unique features of the document that are influenced by the printing component data at block 704. Unique features may include document file type, color requirements of the document, paper requirements of the document, orientation of content in the document, margins in the document, images in the document, images requiring enhancement in the document, coversheets in the document, insert or section headers in the document, duplexing requirements of the document, and binding requirements of the document.

After content in the document has been scanned and analyzed for unique features, the AI smart search system 200 may continue operate in performing subroutine 800, subroutine 900, and/or subroutine 1000. These subroutines are described in greater detail below.

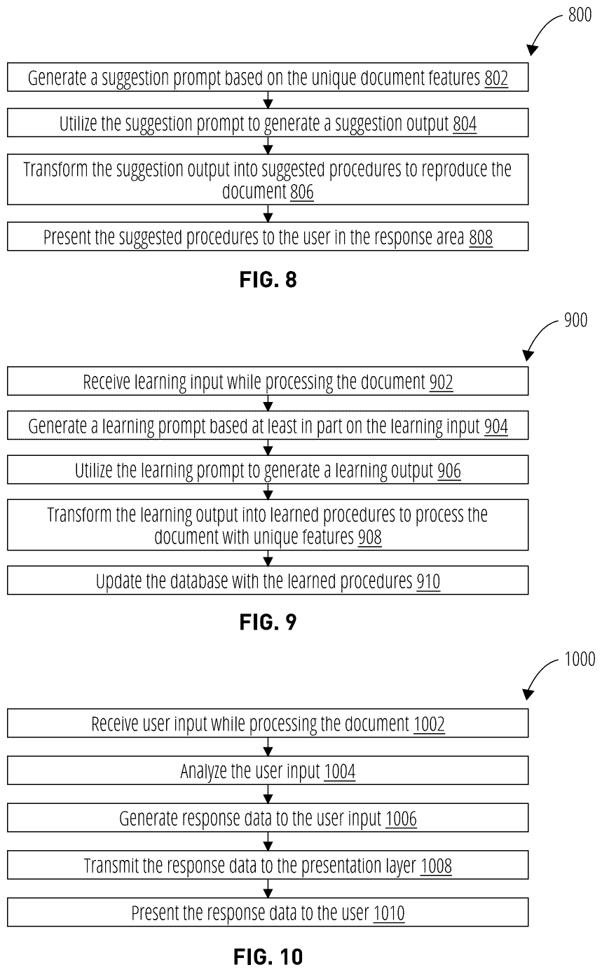

FIG. 8 illustrates an example subroutine 800 that may be performed by the AI smart search system 200. Although the example subroutine 800 depicts a particular sequence of operations, the sequence may be altered without departing from the scope of the present disclosure. For example, some of the operations depicted may be performed in parallel or in a different sequence that does not materially affect the function of the subroutine 800. In other examples, different components of an example device or system that implements the subroutine 800 may perform functions at substantially the same time or in a specific sequence.

According to some examples, the method includes, at block 802, generating a suggestion prompt based on the unique features of the document determined at block 704. For example, the prompt composer 304 illustrated in FIG. 3 may generate a suggestion prompt based on the unique document features. The suggestion prompt may be based on at least the unique features of the scanned document and may take other input data into account as well.

According to some examples, the method includes utilizing the suggestion prompt to generate a suggestion output at block 804. For example, the pre-trained GenAI model 306 illustrated in FIG. 3 may utilize the suggestion prompt to generate a suggestion output.

According to some examples, the method includes transforming the suggestion output into suggested procedures to at least one of reproduce the document and enhance the contents in the document at block 806. For example, the AI smart search engine 300 illustrated in FIG. 3 may transform the suggestion output into suggested procedures to reproduce or enhance the document. The transformer 322 logic may be used to transform the suggestion output.

According to some examples, the method includes presenting the suggested procedures to the user in the response area at block 808. For example, the presentation layer 204 illustrated in FIG. 2 may present the suggested procedures to the user in the response area.

FIG. 9 illustrates an example subroutine 900 that may be performed by the AI smart search system 200. Although the example subroutine 900 depicts a particular sequence of operations, the sequence may be altered without departing from the scope of the present disclosure. For example, some of the operations depicted may be performed in parallel or in a different sequence that does not materially affect the function of the subroutine 900. In other examples, different components of an example device or system that implements the subroutine 900 may perform functions at substantially the same time or in a specific sequence.

According to some examples, the method includes, at block 902, receiving learning input including at least one of the operating data and the user prompt while processing the document scanned at block 702. For example, the AI smart search engine 300 illustrated in FIG. 3 may receive learning input including at least one of the operating data and the user prompt while processing the document.

According to some examples, the method includes generating, by the prompt composer, a learning prompt based at least in part on the learning input at block 904. According to some examples, the method includes utilizing, by the pre-trained GenAI model, the learning prompt, to generate a learning output at block 906.

According to some examples, the method includes transforming, by the AI smart search engine, the learning output into learned procedures to process the document with the unique features at block 908. According to some examples, the method includes updating the database with the learned procedures for processing documents with similar unique features at block 910.

FIG. 10 illustrates an example subroutine 1000 that may be performed by the AI smart search system 200. Although the example subroutine 1000 depicts a particular sequence of operations, the sequence may be altered without departing from the scope of the present disclosure. For example, some of the operations depicted may be performed in parallel or in a different sequence that does not materially affect the function of the subroutine 1000. In other examples, different components of an example device or system that implements the subroutine 1000 may perform functions at substantially the same time or in a specific sequence.

According to some examples, the method includes, at block 1002, receiving user input while processing the document scanned at block 702. For example, the AI smart search engine 300 illustrated in FIG. 3 may receive user input while processing the document. The user input may include at least one of the operating data from the printing component and the user prompt from the user.

According to some examples, the method includes analyzing the user input at block 1004. For example, the AI smart search engine 300 illustrated in FIG. 3 may analyze the user input. According to some examples, the method includes generating response data to the user input at block 1006. For example, the AI smart search engine 300 illustrated in FIG. 3 may generate response data to the user input.

According to some examples, the method includes transmitting the response data to the presentation layer at block 1008. For example, the AI smart search engine 300 illustrated in FIG. 3 may transmit the response data to the presentation layer. According to some examples, the method includes presenting the response data to the user at block 1010. For example, the presentation layer 204 illustrated in FIG. 2 may present the response data to the user in a response area 206.

The following figures set forth, without limitation, exemplary artificial intelligence-based systems that may be used to implement at least one embodiment of the AI smart search engine 300 implemented in the disclosed AI smart search system 200.

FIG. 11A illustrates inference and/or training logic 1100a used to perform inferencing and/or training operations associated with one or more embodiments. Details regarding training logic/hardware structure 1110 are provided below in conjunction with FIG. 11A and/or FIG. 11B.

In at least one embodiment, training logic/hardware structure 1110 may include, without limitation, code and/or data storage 1102 to store forward and/or output weight and/or input/output data, and/or other parameters to configure neurons or layers of a neural network trained and/or used for inferencing in aspects of one or more embodiments. In at least one embodiment, training logic/hardware structure 1110 may include or be coupled to code and/or data storage 1102 to store graph code or other software to control the timing and/or order in which weight and/or other parameter information is to be loaded to configure logic, including integer and/or floating-point units (collectively, arithmetic logic units (ALUs)). In at least one embodiment, code, such as graph code, loads weight or other parameter information into processor ALUs based on an architecture of a neural network to which such code corresponds. In at least one embodiment code and/or data storage 1102 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1102 may be included with other on-chip or off-chip data storage, including a processor's L1, L2, or L3 cache or system memory.

In at least one embodiment, any portion of code and/or data storage 1102 may be internal or external to one or more processors or other hardware logic devices or circuits. In at least one embodiment, code and/or data storage 1102 may be cache memory, dynamic randomly addressable memory (DRAM), static randomly addressable memory (SRAM), non-volatile memory (e.g., flash memory), or other storage. In at least one embodiment, a choice of whether code and/or data storage 1102 is internal or external to a processor, for example, or comprising DRAM, SRAM, flash, or some other storage type may depend on available storage on-chip versus off-chip, latency requirements of training and/or inferencing functions being performed, batch size of data used in inferencing and/or training of a neural network, or some combination of these factors.

In at least one embodiment, training logic/hardware structure 1110 may include, without limitation, a code and/or data storage 1106 to store backward and/or output weight and/or input/output data corresponding to neurons or layers of a neural network trained and/or used for inferencing in aspects of one or more embodiments. In at least one embodiment, code and/or data storage 1106 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic/hardware structure 1110 may include or be coupled to code and/or data storage 1106 to store graph code or other software to control the timing and/or order in which weight and/or other parameter information is to be loaded to configure logic, including integer and/or floating-point units (collectively, arithmetic logic units (ALUs)).

In at least one embodiment, code, such as graph code, causes loading of weight or other parameter information into processor ALUs based on an architecture of a neural network to which such code corresponds. In at least one embodiment, any portion of code and/or data storage 1106 may be included with other on-chip or off-chip data storage, including a processor's L1, L2, or L3 cache or system memory. In at least one embodiment, any portion of code and/or data storage 1106 may be internal or external to one or more processors or other hardware logic devices or circuits. In at least one embodiment, code and/or data storage 1106 may be cache memory, DRAM, SRAM, non-volatile memory (e.g., flash memory), or other storage. In at least one embodiment, a choice of whether code and/or data storage 1106 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1102 and code and/or data storage 1106 may be separate storage structures. In at least one embodiment, code and/or data storage 1102 and code and/or data storage 1106 may be a combined storage structure. In at least one embodiment, code and/or data storage 1102 and code and/or data storage 1106 may be partially combined and partially separate. In at least one embodiment, any portion of code and/or data storage 1102 and code and/or data storage 1106 may be included with other on-chip or off-chip data storage, including a processor's L1, L2, or L3 cache or system memory.

In at least one embodiment, training logic/hardware structure 1110 may include, without limitation, one or more arithmetic logic units 1112, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1114 that are functions of input/output and/or weight parameter data stored in code and/or data storage 1102 and/or code and/or data storage 1106. In at least one embodiment, activations stored in activation storage 1114 are generated according to linear algebraic and or matrix-based mathematics performed by arithmetic logic units 1112 in response to performing instructions or other code, wherein weight values stored in code and/or data storage 1106 and/or code and/or data storage 1102 are used as operands along with other values, such as bias values, gradient information, momentum values, or other parameters or hyperparameters, any or all of which may be stored in code and/or data storage 1106 or code and/or data storage 1102 or another storage on or off-chip.

In at least one embodiment, arithmetic logic units 1112 are included within one or more processors or other hardware logic devices or circuits, whereas in another embodiment, arithmetic logic units 1112 may be external to a processor or other hardware logic device or circuit that uses them (e.g., a co-processor). In at least one embodiment, arithmetic logic units 1112 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or code and/or data storage 1102, code and/or data storage 1106, and activation storage 1114 may share a processor or other hardware logic device or circuit, whereas, in another embodiment, they may be in different processors or other hardware logic devices or circuits, or some combination of same and different processors or other hardware logic devices or circuits. In at least one embodiment, any portion of activation storage 1114 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logic circuits.

In at least one embodiment, activation storage 1114 may be cache memory, DRAM, SRAM, non-volatile memory (e.g., flash memory), or other storage. In at least one embodiment, activation storage 1114 may be completely or partially within or external to one or more processors or other logic circuits. In at least one embodiment, a choice of whether activation storage 1114 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, the training logic/hardware structure 1110 illustrated in FIG. 11A may be used in conjunction with an application-specific integrated circuit (ASIC), such as a TensorFlow® Processing Unit from Google, an inference processing unit (IPU) from Graphcore™, or a Nervana® (e.g., “Lake Crest) processor from Intel Corp. In at least one embodiment, the training logic/hardware structure 1110 illustrated in FIG. 11A may be used in conjunction with central processing unit (CPU) hardware, graphics processing unit (GPU) hardware, or other hardware, such as field programmable gate arrays (FPGAs).

FIG. 11B illustrates inference and/or training logic 1100b, according to at least one embodiment. In at least one embodiment, training logic/hardware structure 1110 may include, without limitation, hardware logic in which computational resources are dedicated or otherwise exclusively used in conjunction with weight values or other information corresponding to one or more layers of neurons within a neural network. In at least one embodiment, the training logic/hardware structure 1110 illustrated in FIG. 11B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, the training logic/hardware structure 1110 illustrated in FIG. 11B may be used in conjunction with central processing unit (CPU) hardware, graphics processing unit (GPU) hardware, or other hardware, such as field programmable gate arrays (FPGAs). In at least one embodiment, training logic/hardware structure 1110 includes, without limitation, code and/or data storage 1102 and code and/or data storage 1106, which may be used to store code (e.g., graph code), weight values and/or other information, including bias values, gradient information, momentum values, and/or other parameter or hyperparameter information. In at least one embodiment illustrated in FIG. 11B, each of code and/or data storage 1102 and code and/or data storage 1106 is associated with a dedicated computational resource, such as computational hardware 1104 and computational hardware 1108, respectively. In at least one embodiment, each of computational hardware 1104 and computational hardware 1108 comprises one or more ALUs that perform mathematical functions, such as linear algebraic functions, on information stored in code and/or data storage 1102 and code and/or data storage 1106, respectively, the result of which is stored in activation storage 1114.

In at least one embodiment, each of code and/or data storage 1102 and 1106 and corresponding computational hardware 1104 and 1108, respectively, correspond to different layers of a neural network, such that resulting activation from one storage/computational pair 1102/1104 of code and/or data storage 1102 and computational hardware 1104 is provided as an input to a next storage/computational pair 1106/1108 of code and/or data storage 1106 and computational hardware 1108, in order to mirror a conceptual organization of a neural network. In at least one embodiment, each of the storage/computational pairs 1102/1104 and 1106/1108 may correspond to more than one neural network layer. In at least one embodiment, additional storage/computation pairs (not shown) subsequent to or in parallel with storage/computation pairs 1102/1104 and 1106/1108 may be included in training logic/hardware structure 1110.

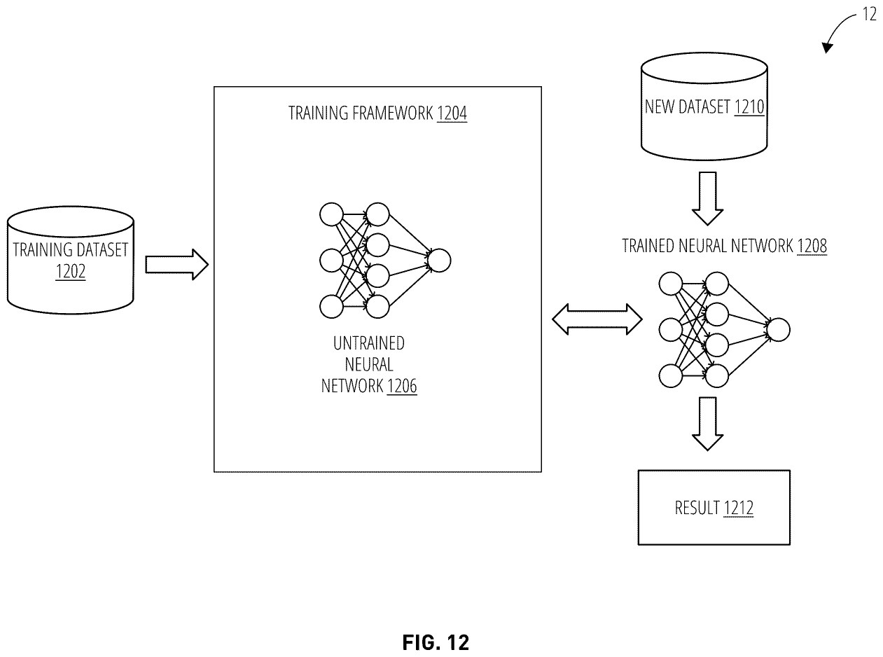

FIG. 12 illustrates the training and deployment of a deep neural network 1200, according to at least one embodiment. In at least one embodiment, untrained neural network 1206 is trained using a training dataset 1202. In at least one embodiment, training framework 1204 is a PyTorch framework, whereas in other embodiments, training framework 1204 is a TensorFlow, Boost, Caffe, Microsoft Cognitive Toolkit, Microsoft Computational Network Toolkit (CNTK), MXNet, Chainer, Keras, Deeplearning4j, or another training framework 1204. In at least one embodiment, training framework 1204 trains an untrained neural network 1206 and allows it to be trained using processing resources described herein to generate a trained neural network 1208. In at least one embodiment, weights may be chosen randomly or by pre-training using a deep belief network. In at least one embodiment, training may be performed in either a supervised, partially supervised, or unsupervised manner.

In at least one embodiment, untrained neural network 1206 is trained using supervised learning, wherein training dataset 1202 includes an input paired with a desired output for the input, or where training dataset 1202 includes input having a known output and an output of untrained neural network 1206 is manually graded. In at least one embodiment, untrained neural network 1206 is trained in a supervised manner, processes inputs from training dataset 1202, and compares resulting outputs against a set of expected or desired outputs. In at least one embodiment, errors are then propagated back through untrained neural network 1206. In at least one embodiment, training framework 1204 adjusts weights that control untrained neural network 1206. In at least one embodiment, training framework 1204 includes tools to monitor how well untrained neural network 1206 is converging towards a model, such as trained neural network 1208, suitable to generating correct answers, such as in result 1212, based on input data such as a new dataset 1210. In at least one embodiment, training framework 1204 trains untrained neural network 1206 repeatedly while adjusting weights to refine an output of untrained neural network 1206 using a loss function and adjustment algorithm, such as stochastic gradient descent. In at least one embodiment, training framework 1204 trains untrained neural network 1206 until untrained neural network 1206 achieves the desired accuracy. In at least one embodiment, trained neural network 1208 may then be deployed to implement any number of machine learning operations.

In at least one embodiment, untrained neural network 1206 is trained using unsupervised learning, wherein untrained neural network 1206 attempts to train itself using unlabeled data. In at least one embodiment, an unsupervised learning training dataset 1202 will include input data without any associated output data or “ground truth” data. In at least one embodiment, untrained neural network 1206 may learn groupings within training dataset 1202 and may determine how individual inputs are related to other data in the training dataset 1202. In at least one embodiment, unsupervised training may be used to generate a self-organizing map in a trained neural network 1208 capable of performing operations useful in reducing the dimensionality of the new dataset 1210. In at least one embodiment, unsupervised training may also be used to perform anomaly detection, which allows the identification of data points in new dataset 1210 that deviate from normal patterns of new dataset 1210.

In at least one embodiment, semi-supervised learning may be used, which is a technique in which training dataset 1202 includes a mix of labeled and unlabeled data. In at least one embodiment, training framework 1204 may be used to perform incremental learning, such as through transferred learning techniques. In at least one embodiment, incremental learning allows trained neural network 1208 to adapt to new dataset 1210 without forgetting knowledge instilled within trained neural network 1208 during initial training.

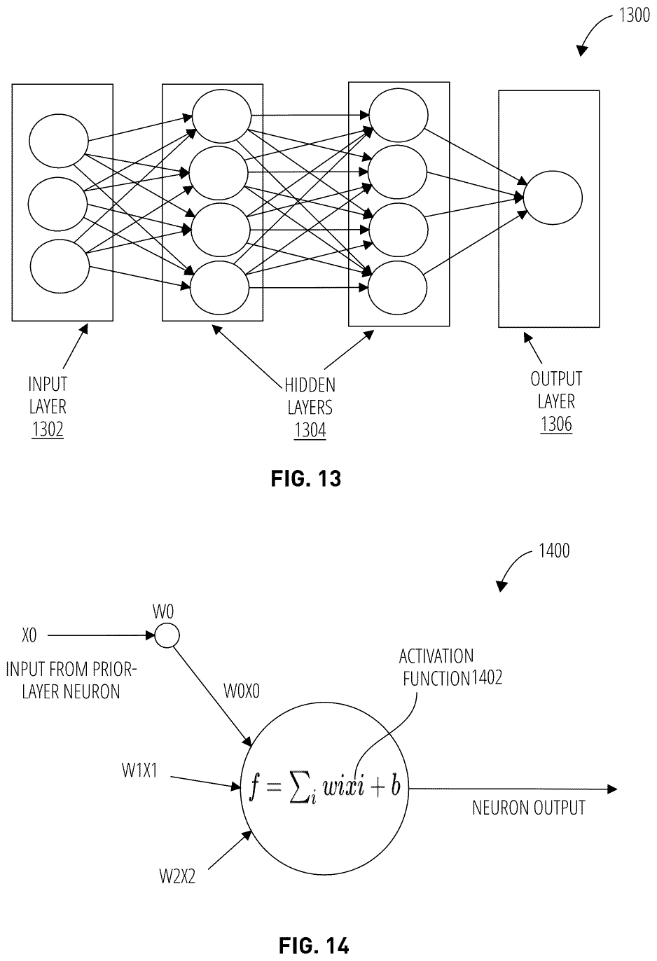

FIG. 13 illustrates a basic deep neural network 1300 in accordance with one embodiment. A basic deep neural network 1300 is based on a collection of connected units or nodes called artificial neurons which loosely model the neurons in a biological brain. Each connection, like the synapses in a biological brain, may transmit a signal from one artificial neuron to another. An artificial neuron that receives a signal may process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is may be sent if the aggregate signal crosses that threshold. Typically, artificial neurons are aggregated into layers. Different layers may perform different kinds of transformations on their inputs. Signals travel from the first layer (the input layer 1302), to the last layer (the output layer 1306), possibly after traversing one or more intermediate layers, called hidden layers 1304.

Referring to FIG. 14, an artificial neuron 1400 receiving inputs from predecessor neurons consists of the following components:
inputs xᵢ;
weights wᵢ applied to the inputs;
an optional threshold (b), which stays fixed unless changed by a learning function; and
an activation function 1402 that computes the output from the previous neuron inputs and threshold, if any.

An input neuron has no predecessor but serves as input interface for the whole network. Similarly, an output neuron has no successor and thus serves as output interface of the whole network.

The network includes connections, each connection transferring the output of a neuron in one layer to the input of a neuron in a next layer. Each connection carries an input x and is assigned a weight w.

The activation function 1402 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

FIG. 15 illustrates an embodiment of a computational apparatus 1500 to implement components and process steps of the system described herein.

Input devices 1504 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 1504 are keyboards which respond to touch or physical pressure from an object or proximity of an object to a surface, mice which respond to motion through space or across a plane, microphones which convert vibrations in the medium (typically air) into device signals, scanners which convert optical patterns on two-or three-dimensional objects into device signals. The signals from the input devices 1504 are provided via various machine signal conductors (e.g., busses or network interfaces) and circuits to memory 1506.

The memory 1506 is typically what is known as a first or second level memory device, providing for storage (via configuration of matter or states of matter) of signals received from the input devices 1504, instructions and information for controlling operation of the processor 1502, and signals from storage devices 1510.

The memory 1506 and/or the storage devices 1510 may store computer-executable instructions and thus forming logic 1514 that when applied to and executed by the processor 1502 implement embodiments of the processes disclosed herein.

Information stored in the memory 1506 is typically directly accessible to the processor 1502 of the device. Signals input to the device cause the reconfiguration of the internal material/energy state of the memory 1506, creating in essence a new machine configuration, influencing the behavior of the computational apparatus 1500 by affecting the behavior of the processor 1502 with control signals (instructions) and data provided in conjunction with the control signals.

Second or third level storage devices 1510 may provide a slower but higher capacity machine memory capability. Examples of storage devices 1510 are hard disks, optical disks, large capacity flash memories or other non-volatile memory technologies, and magnetic memories.

The processor 1502 may cause the configuration of the memory 1506 to be altered by signals in storage devices 1510. In other words, the processor 1502 may cause data and instructions to be read from storage devices 1510 in the memory 1506 from which may then influence the operations of processor 1502 as instructions and data signals, and from which it may also be provided to the output devices 1508. The processor 1502 may alter the content of the memory 1506 by signaling to a machine interface of memory 1506 to alter the internal configuration, and then converted signals to the storage devices 1510 to alter its material internal configuration. In other words, data and instructions may be backed up from memory 1506, which is often volatile, to storage devices 1510, which are often non-volatile.

Output devices 1508 are transducers which convert signals received from the memory 1506 into physical phenomenon such as vibrations in the air, or patterns of light on a machine display, or vibrations (i.e., haptic devices) or patterns of ink or other materials (i.e., printers and 3-D printers).

The network interface 1512 receives signals from the memory 1506 and converts them into electrical, optical, or wireless signals to other machines, typically via a machine network. The network interface 1512 also receives signals from the machine network and converts them into electrical, optical, or wireless signals to the memory 1506.

Terms used herein are to be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine-readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly indicates otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting their operation or function. For example, an association operation may be carried out by an “associator” or “correlator”. Likewise, switching may be carried out by a “switch”, selection by a “selector”, and so on.

FIG. 16 illustrates a cloud computing environment 1600 including network connected cloud resource 1602, in accordance with at least one embodiment. In at least one embodiment, network connected cloud resource 1602 comprises one or more computer systems/servers 1604 with which computing devices such as, personal digital assistant (PDA) or computing device 1606a, computing device 1606b, computing device 1606c, and/or computing device 1606d communicate. In at least one embodiment, this allows for infrastructure, platforms, and/or software to be offered as services from network connected cloud resource 1602, so as to not require each client to separately maintain such resources. It is understood that the types of computing devices 1606a-1606d shown in FIG. 16 (a mobile or handheld device, a desktop computer, a laptop computer, and an automobile computer system) are intended to be illustrative, and that network connected cloud resource 1602 may communicate with any type of computerized device over any type of network and/or network/addressable connection (e.g., using a web browser).

In at least one embodiment, a computer system or server 1604, which may be denoted as a cloud computing node, is operational with numerous other general purpose or special purpose computing system environments or configurations. In at least one embodiment, examples of computing systems, environments, and/or configurations that may be suitable for use with computer system or server 1604 include, but are not limited to, personal computer systems, server computer systems, thin clients, thick clients, hand-held or laptop devices, multiprocessor systems, microprocessor-based systems, set-top boxes, programmable consumer electronics, network personal computers (PCs), minicomputer systems, mainframe computer systems, and distributed cloud computing environments that include any of the above systems or devices, and/or variations thereof.

In at least one embodiment, computer system or server 1604 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, an exemplary computer system or server 1604 may be practiced in distributed cloud computing environments where tasks are performed by remote processing devices that are linked through a communications network. In at least one embodiment, in a distributed cloud computing environment, program modules may be located in both local and remote computer system storage media including memory storage devices.

FIG. 17 illustrates a set of functional abstraction layers 1700 provided by network connected cloud resource 1602 in a cloud computing environment 1600 (FIG. 16), in accordance with at least one embodiment. It should be understood in advance that the components, layers, and functions shown in FIG. 17 are intended to be illustrative, and components, layers, and functions may vary.

In at least one embodiment, hardware and software layer 1702 includes hardware and software components. In at least one embodiment, examples of hardware components include mainframes, various RISC (Reduced Instruction Set Computer) architecture-based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 1704 provides an abstraction layer from which the following exemplary virtual entities may be provided: virtual servers, virtual storage, virtual networks, including virtual private networks, virtual applications, virtual clients, and/or variations thereof.

In at least one embodiment, management layer 1706 provides various functions. In at least one embodiment, resource provisioning provides dynamic procurement of computing resources and other resources that are utilized to perform tasks within a cloud computing environment 1600. In at least one embodiment, metering provides usage tracking as resources are utilized within a cloud computing environment 1600, and billing or invoicing for consumption of these resources. In at least one embodiment, resources may comprise application software licenses. In at least one embodiment, security provides identity verification for users and tasks, as well as protection for data and other resources. In at least one embodiment, a user interface provides access to a cloud computing environment 1600 for both users and system administrators. In at least one embodiment, service level management provides cloud computing resource allocation and management such that the necessary service levels are met. In at least one embodiment, Service Level Agreement (SLA) management provides pre-arrangement for, and procurement of, cloud computing resources for which a future requirement is anticipated in accordance with an SLA.

In at least one embodiment, workloads layer 1708 provides functionality for which a cloud computing environment 1600 is utilized. In at least one embodiment, examples of workloads and functions which may be provided from this layer include mapping and navigation, software development and management, educational services, data analytics and processing, transaction processing, and service delivery.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting the operation or function. For example, an association operation may be carried out by an “associator” or “correlator”. Likewise, switching may be carried out by a “switch”, selection by a “selector”, and so on.

What is claimed is:

1. A system comprising:
a printing component including:
an AI smart search engine configured to receive an input including at least one of operating data from the printing component, a user prompt from a user, and printing component data in a database, the printing component data including at least one of:
printer settings;
printing features;
printing capabilities;
printing procedures; and
maintenance procedures;
a presentation layer including a response area, the presentation layer configured to at least one of:
receive response data from the AI smart search engine;
present the response data to the user; and
receive the user prompt from the user;
a prompt composer configured to receive the input to generate a search prompt that incorporates the input;
a pre-trained Generative Artificial Intelligence (GenAI) model configured to utilize the search prompt and the database to generate an output;
logic to:
tokenize the at least one of the operating data and the user prompt into operating data tokens and user prompt tokens suitable to prompt the pre-trained GenAI model;
generate the search prompt from at least one of the operating data tokens and the user prompt tokens;
analyze, by the AI smart search engine, the search prompt to create associations and relationships with the printing component data;
prompt the pre-trained GenAI model with the search prompt and receive the output from the pre-trained GenAI model; and
transform, by the AI smart search engine, the output into the response data.

2. The system of claim 1, wherein the printing component is at least one of:
a printer driver, a printer panel firmware, a printer firmware, a printer application, and software including a Digital Front End (DFE) application.

3. The system of claim 1, wherein the response area is configured to display at least one of:
dynamic system settings;
textual responses;
graphical responses;
diagrammatic responses;
printing component statistics; and
printing component status.

4. The system of claim 1, wherein the search prompt includes at least one of:
settings for printing different document types;
printing tasks;
maintenance tasks;
creative tasks;
color management; and
scheduled tasks.

5. The system of claim 1, wherein the printer settings include at least one of:
a configuration file for the printing component including at least one of:
a .ppd file for printer drivers;
a .json file for printing applications;
a .xml file or a .xsd file for Job Definition Format (JDF) or Exchange JDF (XJDF) systems; and
a .cfg file for applications; and
configuration data saved in database files or database systems.

6. The system of claim 1, wherein the printing procedures include at least one of:
descriptive printing procedures that are configured to be performed in the printing component;
outline printing procedures that are configured to be performed in the printing component; and
step-by-step guides for performing the printing procedures.

7. The system of claim 1, wherein the maintenance procedures include at least one of:
a step-by-step guide in performing at least one of: print head alignment, color registration, and memory initialization;
a step-by-step guide in performing at least one of: loading media and making associated setting changes in certain media trays; and
a step-by-step guide in cleaning ink waste bins.

8. The system of claim 1, wherein the AI smart search engine receives prompts from the user for at least one of:
settings examples;
printing tasks;
maintenance tasks;
creative tasks;
color management; and
scheduled tasks.

9. The system of claim 1, wherein the response data includes at least one of:
procedures that guide the user in performing printing tasks; and
step-by-step guides with details on at least one of:
selecting specific media to load into the printing component;
loading a specific feeding edge of media into the printing component; and
orientating media to load into the printing component.

10. The system of claim 1, further comprising the logic to:
scan content in at least a portion of a document;
identify unique features of the content of the document that are influenced by the printing component data;
generate, by the prompt composer, a suggestion prompt based at least in part on the unique features of the content in the document;
utilize, by the pre-trained GenAI model, the suggestion prompt, to generate a suggestion output;
transform, by the AI smart search engine, the suggestion output into suggested procedures to at least one of reproduce the document and enhance the content in the document; and
present the suggested procedures to the user in the response area.

11. A method comprising:
receiving, by an AI smart search engine, an input including at least one of operating data from a printing component, a user prompt from a user, and printing component data from a database, wherein the printing component data includes at least one of:
printer settings;
printing features;
printing capabilities;
printing procedures; and
maintenance procedures;
receiving, by a prompt composer, the input,
generating, by the prompt composer, a search prompt that incorporates the input;
analyzing, by the AI smart search engine, the search prompt to create associations and relationships with the printing component data;
utilizing, by a pre-trained Generative Artificial Intelligence (GenAI) model, the search prompt and the database to generate an output;
transforming, by the AI smart search engine, the output into response data; and
presenting, by a presentation layer, the response data to the user, wherein the presentation layer includes a response area and is configured to at least one of:
receive the response data from the AI smart search engine;
present the response data to the user; and
receive the user prompt from the user.

12. The method of claim 11, further comprising:
scanning content in at least a portion of a document;
identifying unique features of the content of the document that are influenced by the printing component data.

13. The method of claim 12, further comprising:
generating, by the prompt composer, a suggestion prompt based at least in part on the unique features of the document;
utilizing, by the pre-trained GenAI model, the suggestion prompt, to generate a suggestion output;
transforming, by the AI smart search engine, the suggestion output into suggested procedures to at least one of reproduce the document and enhance content in the document;
presenting the suggested procedures to the user in the response area.

14. The method of claim 12, further comprising:
receiving, by the AI smart search engine, learning input including at least one of the operating data from the printing component and the user prompt from the user, while processing the document;
generating, by the prompt composer, a learning prompt based at least in part on the learning input;
utilizing, by the pre-trained GenAI model, the learning prompt, to generate a learning output;
transforming, by the AI smart search engine, the learning output into learned procedures to process the document with the unique features;
updating the database with the learned procedures for processing documents with similar unique features.

15. The method of claim 12, further comprising:
receiving, by the AI smart search engine, user input including at least one of the operating data from the printing component and the user prompt from the user, while processing the document;
analyzing, by the AI smart search engine, the user input;
generating, by the AI smart search engine, the response data to the user input;
transmitting the response data to the presentation layer; and
presenting, by the presentation layer, the response data to the user.

16. The method of claim 12, wherein the unique features include at least one of:
document file type;
color requirements of the document;
paper requirements of the document;
orientation of content in the document;
margins in the document;
images in the document;
images requiring enhancement in the document;
coversheets in the document;
insert or section headers in the document;
duplexing requirements of the document; and
binding requirements of the document.

17. The method of claim 11, wherein the printing procedures include at least one of:
descriptive printing procedures that are configured to be performed in the printing component;
outline printing procedures that are configured to be performed in the printing component; and
step-by-step guides for performing the printing procedures.

18. The method of claim 11, wherein the printing component is at least one of:
a printer driver, a printer panel firmware, a printer firmware, a printer application, and software including a Digital Front End (DFE) application.

19. The method of claim 11, wherein the maintenance procedures include at least one of:
performing, using a step-by-step guide, at least one of: print head alignment, color registration, and memory initialization;
performing, using a step-by-step guide, at least one of: loading media and making associated setting changes in certain media trays; and
cleaning, using a step-by-step guide, ink waste bins.

20. The method of claim 11, performing a procedure in the response data or following a step-by-step guide in the response data, wherein the response data includes at least one of:
procedures that guide the user in performing printing tasks; and
step-by-step guides with details on at least one of:
selecting specific media to load into the printing component;
loading a specific feeding edge of media into the printing component; and
orientating media to load into the printing component.
